(19) United States
(12) Patent Application Publication
(10) Pub. No.: US 2014/0364196 A1
(43) Pub. Date: Dec. 11, 2014

(54) METHOD, SYSTEM, AND DEVICE FOR CONDUCTING A GAME

(71) Applicant: David Nizgoda, Las Vegas, NV (US)

(72) Inventor: David Nizgoda, Las Vegas, NV (US)

(21) Appl. No.: 14/468,232

(22) Filed: Aug. 25, 2014

Related U.S. Application Data
(63) Continuation-in-part of application No. 14/093,868, filed on Dec. 2, 2013, now Pat. No. 8,814,166.
(60) Provisional application No. 61/854,944, filed on May 6, 2013.

(51) Int. Cl. G07F 17/32

(52) U.S. Cl. CPC G07F 17/3293; G07F 17/3244
USPC 463/22

(57) ABSTRACT

A method, system, and device for conducting a game includes receiving a war base wager and a base game wager. A player war hand and dealer war hand are dealt. The war base wager is resolved based on a comparison between the player war hand and dealer war hand. Optionally, the base game wager may be supplemented by any war payout, or a portion thereof. A player base game hand and a dealer base game hand are dealt. Optionally, the player base game hand and/or dealer base game hand contain the player war hand and/or dealer war hand, respectively. Optionally, the base game wager is resolved using the player base game hand and the dealer base game hand which are compared to one another.

### RELATED APPLICATION DATA

The present application claims the priority of U.S. Provisional Application Ser. No. 61/854,944, entitled “Casino War Blackjack,” filed May 6, 2013, and is a continuation in part of U.S. patent application Ser. No. 14/093,868, entitled “Method, System, and Device for Conducting a Game,” filed Dec. 2, 2013.

### FIELD OF THE INVENTION

The present invention relates to methods, systems, and devices for conducting games. More particularly, the present invention includes methods, systems, and devices for conducting a casino game having a first stage in which a player war hand is compared to a dealer war hand to resolve a war base wager, and a second stage in which a player base hand is compared to a dealer base hand to resolve a base game wager.

### BACKGROUND OF THE INVENTION

Blackjack is a well-known card game conducted in casinos. The object of the game is to have a final hand total closer to twenty-one than the final dealer hand total is, without exceeding twenty-one. For purposes of calculating the final hand total, each card has a value equal to its face value except face cards, which have a value of ten, and Aces, which may have a value of eleven or one, depending on which forms the best hand. In conventional blackjack, the suit of the cards is irrelevant. A final hand total that exceeds twenty-one is said to “bust” and is considered a losing hand.

The form of blackjack conducted in casinos is banked by the house and is played between a dealer, representing the house, and at least one player. In a typical blackjack game, each player makes a base wager in a wagering area on a playing surface. The dealer deals an initial player hand containing two cards to each player and an initial dealer hand containing two cards to himself or herself. The two cards of the initial dealer hand may be dealt together, with one card face up and the other face down, or dealt separately, with a first card dealt before completing the players' hands and a second card dealt after completing the players' hands.

If the initial dealer hand does not have a natural twenty one, any initial player hand receiving a natural twenty-one or blackjack, i.e. a total of twenty-one in the initial dealt hand, is immediately rewarded, typically at a rate of 2:1, 3:2, or 6:5, and play is terminated as to that player. Each remaining player examines his or her initial player hand and decides whether to hit, i.e. receive another card, or stand, i.e. stop with the current hand. A player may hit as many times as the player wishes as long as the player does not bust, i.e. receive a card causing the cumulative sum of the values of the cards in the player's hand to exceed twenty-one. When a player busts, the player's wager is immediately collected and play is terminated as to that player.

A player may have additional options available depending on the initial player hand dealt. For example, a player may have the option to double down. Although the availability of the double down option vary from casino to casino, doubling down allows a player to double the player's wager in exchange for a single additional card dealt to the initial player hand. This option is typically selected when a player feels that he or she has a reasonable chance of winning by drawing only a single card. This is often the case when the player has an initial two-card total of ten or eleven, so that any ten-value card will give the player a total of twenty or twenty-one, or when the dealer has an exposed card of a five or six, and the player feels it likely that the dealer will bust.

A player may also have the option to split the initial player hand. Specifically, if the player receives a pair, i.e. two cards having the same card value, the player may split the pair and use each card as a basis for a separate hand. For example, if a player were to be dealt a pair of eights, the player may choose to split the pair and continue play with two separate hands each containing an eight and an additional dealt card. Each of the individual split hands is played independently, with the player free to hit or stand (or, possibly, split or double down depending on the house rules) the newly formed split hands.

After all the players have formed final hands, the dealer reveals the face-down card in the dealer hand. The dealer completes the dealer hand according to established house rules. That is, the casino uses established rules to eliminate discretion by the dealer in forming the dealer hand and the dealer hits or stands as the house rules dictate. The final dealer hand is compared to each final player hand and the target value of twenty one to resolve the wagers. In resolving the wagers, a player hand outranks or beats a dealer hand if the total sum of the cards in the player hand is closer to twenty-one than the total sum of the cards in the dealer hand is. For example, if the final dealer hand has a total sum of nineteen and a final player hand has a total sum of twenty, the final player hand “wins” because it is closer to the target value of twenty-one than the final dealer hand is. Wagers on winning player hands are typically rewarded at even money, i.e., 1:1. Wagers are collected from player hands with a final hand total further from twenty-one than the final hand total of the dealer hand is. If the dealer hand busts, all players who did not bust or receive a blackjack are rewarded. If the player and dealer push, i.e., have hands with the same final hand total, the player's wager is returned.

Another well known casino game is Baccarat. Baccarat is a live table game that uses a standard deck of fifty-two playing cards. The object of Baccarat is for a player to successfully wager on which of two community hands, designated the Banker hand and the Player hand, is going to win. The player is paid even money for the wager if he or she wagers on the winning hand and loses the wager if he or she selects the losing hand. In an optional embodiment, a tie wager may also be offered. In such an optional embodiment, the tie wager is paid at greater than even money when the Banker hand value and Player hand value are equal.

Play of Baccarat is commenced after all wagers are made by dealing two-cards to the Banker hand and dealing two-cards to the Player hand. The cards are turned face up and the values of the Banker hand and the Player hand are determined by summing the face values of the cards in each hand, modulo ten. That is, if the values of the cards are added together and the total of the hand exceeds nine, then the hand value is determined by the remainder after dividing by ten. In other words, all hand values range from a low of zero to a high of nine. For example, a seven and an eight total fifteen, but the hand value is five. An Ace and a nine total ten, but the hand value is zero.

Depending on the hand value of the initial Player hand and the initial Banker hand, one additional card may be dealt to the Player hand, the Banker hand, or both. If either or both of the initial two-card Player hand and the initial Banker hand have a hand value of eight or nine, the wagers are resolved without dealing any additional cards. Specifically, the Player hand wins if the Player hand value is nine and the Banker hand value is eight and the Banker hand wins if the Banker hand value is nine and the Player hand value is eight.

If both the Player hand and Banker hand have a hand value that is less than eight, a third card may be dealt to one or both of the Player hand and/or Banker hand. The rules for determining whether a third card is dealt are fixed; that is, there is no discretion for either the Player hand or the Banker hand on whether a third card is dealt.

Rule #1: If the initial two-card Player hand has a hand value of 0, 1, 2, 3, 4, or 5, the Player hand is dealt a third card. If the initial two-card Player hand has a hand value of 6 or 7, the Player hand stands and is not dealt a third card.

Rule #2: If the Player hand stands and is not dealt a third card, then the Banker hand follows Rule #1. In other words, if the Player hand has a hand value of 6 or 7, the Banker hand is dealt a third card on a hand value of 0, 1, 2, 3, 4, or 5 and the Banker hand stands on a hand value of 6 or 7.

Rule #3: If the Player hand is dealt a third card, the Banker hand must be dealt a third card, or stand, as follows:

| Banker | | |
|---|---|---|
| hand | | |
| two-card | | |
| hand | Banker hand DRAWS when | Banker hand STANDS when |
| value: | Player hand third card is: | Player hand third card is: |
| 0, 1, or 2 | Bank always draws | |
| 3 | 0, 1, 2, 3, 4, 5, 6, 7, or 9 | 8 |
| 4 | 2, 3, 4, 5, 6, or 7 | 0, 1, 8, or 9 |
| 5 | 4, 5, 6, or 7 | 0, 1, 2, 3, 8, or 9 |
| 6 | 6 or 7 | 0, 1, 2, 3, 4, 5, 8, or 9 |
| 7 | | Banker always stands |

After both hands are completed, whichever of the Banker hand or the Player hand that has a hand value closest to nine is the winner. At the end of each hand, winning wagers are paid and losing wagers are collected by the house. Any commission due to the house is marked in commission boxes in the center of the table.

### SUMMARY OF THE INVENTION

The present invention includes a method for conducting a game. The game may be conducted using game pieces. In one optional embodiment, the game pieces are physical playing cards, whether hand-dealt or dealt from an electronic device, such as a card shuffler or card shoe which may include a random number generator to randomize the cards and/or an optical reader to discern the playing cards dealt. Alternatively or additionally, the game may be conducted using electronic representations of playing cards which may be stored in a data storage device and randomly selected by a data processor working cooperatively with a random number generator.

In one optional embodiment, a base game wager and a war base wager are received. The sizes of the base game wager and war base wager may be determined by table limits which fix the minimum, maximum, and/or relative proportion between the base game wager and war base wager.

A player war hand consisting of at least one playing card is dealt. Similarly, a dealer war hand consisting of at least one playing card is dealt. The war base wager is resolved by comparing the player war hand to the dealer war hand and issuing a war payout based on the war base wager when the player war hand outranks the dealer war hand.

In an optional embodiment, an election is received to supplement the base game wager with at least a portion of the war payout, if any. For example, in one optional embodiment, the base game wager may be “capped” with all, or a portion, of the war payout, if any.

A player game hand is dealt. In one optional embodiment, the player game hand includes the player war hand. In an alternate optional embodiment, the player war hand is separate from the player game hand, i.e., the player game hand excludes the player war hand.

A dealer (or banker) game hand is dealt. In one optional embodiment, the dealer (or banker) game hand includes the dealer war hand. In an alternate optional embodiment, the dealer war hand is separate from the dealer (or banker) game hand, i.e., the dealer (or banker) game hand excludes the dealer war hand.

A base game is conducted using the player game hand and dealer (or banker) game hand. In one optional embodiment, an additional playing card (or multiple additional playing cards) may be dealt to the player game hand and/or dealer (or banker) game hand. In an optional embodiment, base game wagers are resolved by comparing the player game hand to the banker game hand to produce a base game outcome. A base game payout is issued based on the base game wager plus any supplement from the war payout if the base game outcome is a winning base game outcome. Conversely, the base game wager (including any supplement from the war payout) is collected if the base game outcome is a losing base game outcome.

### BRIEF DESCRIPTION OF THE DRAWINGS

FIG. 1 is a flow chart of a method according to an embodiment of the present invention;

FIG. 2 is a flow chart of a method according to an embodiment of the present invention;

FIG. 3 is a flow chart of a method according to an embodiment of the present invention;

FIG. 4 is a flow chart of a method according to an embodiment of the present invention;

FIG. 5 is a flow chart of a method according to an embodiment of the present invention;

FIG. 6 is a top view of a player area of a table layout according to an embodiment of the present invention;

FIG. 7 is a block diagram of a device according to an embodiment of the present invention.

### DESCRIPTION

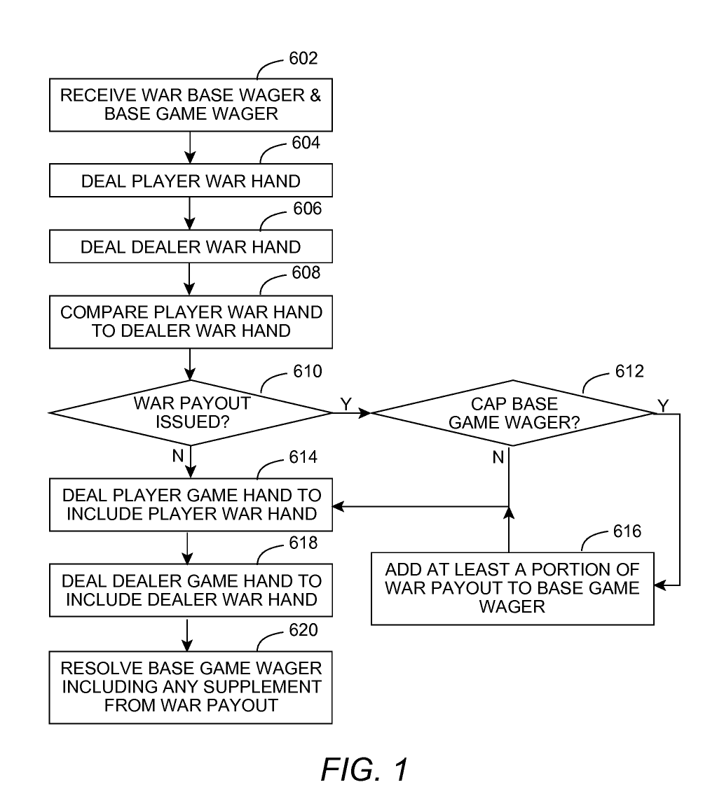

Reference is now made to the figures wherein like parts are referred to by like numerals throughout. Referring to FIGS. 1-7, the present invention includes a method, device, and system for conducting a wagering game. The wagering game may be conducted using any form of game pieces, including dice, tiles, dominoes, playing cards, or the like. The present invention may be implemented as a live table, utilizing a live dealer and physical or electronic playing cards. Additionally, the present invention may be implemented on an electronic device or system, such as an electronic table, electronic gaming machine, electronic table system, personal computer, tablet device, mobile device, or the like. Thus, it is contemplated that the present invention may be conducted as a live game, an electronic game, or a combination thereof and may be conducted using currency or chips or credits which may, or may not, have value. It is also noted that the present invention could be conducted substantially as an electronic game while still using physical playing cards, insofar as a playing card shuffler incorporating a random number generator may be used to randomize and deal playing cards. In this manner, the playing card shuffler functions as machine or device that randomly determines the outcome of the game through an electronic random number generator.

The present invention includes a method as illustrated in FIG. 1. In an optional embodiment, the method is executed at a live table using physical or electronic playing cards. In another optional embodiment, the method is executed by a data processor in a system or device.

In its broadest use, the present invention is a game which is conducted in two or more separately wagered stages, with an election received between the stages to supplement the wagers in an ensuing stage with at least a portion of the winnings from a completed stage. In one such optional embodiment, a base game wager and a war base wager are received 602. In an optional embodiment, both the base game wager and war base wager are received prior to dealing or exposing any game pieces used in the game (e.g., playing cards). In one such optional embodiment, the relative sizes of the base game wager and war base wager may be determined by the operator. For example, the base game wager and war base wager may be required to be the same size. In alternate optional embodiments, the base game wager and war base wager may have any other proportional relationship or no proportional relationship (e.g., the player may place any size wager, within table limits). For example, in one optional embodiment, the maximum war base wager may be twice the maximum base game wager (or vice versa, in other optional embodiments). In yet another optional embodiment, one or both of the war base wager and base game wager may be unlimited. It is also contemplated that the war base wager and base game wager may be received in a form representative of real money or non-monetary credits. That is, the present invention may include an entertainment version in which wagers and payouts are in the form of non-monetary credits that do not represent real money but rather only represent a measure of play of the game. Such non-monetary credits may be free or may be purchased, but cannot be cashed out for real money. It is contemplated, however, that such non-monetary credits may be traded for prizes, accumulated with non-monetary credits for tournament purposes, or serve any other purpose. The present invention may also include a gambling version in which wagers and payouts are in the form of real money, or are exchangeable for real money.

In an optional embodiment, the war base wager may be resolved solely based on the player war hand outranking the dealer war hand (as described in greater detail below). In such an optional embodiment, the war base wager is not accompanied by any designation of the method for resolving the war base wager. In alternate optional embodiments, the war base wager may have multiple possible methods for resolution and, consequently, a war base wager may be accompanied by a designation of the method for resolving the war base wager and/or multiple war base wagers may be received. For example, in various optional embodiments, a player may have the option to place a war base wager on: the player war hand against the dealer war hand; the dealer war hand against the player war hand; the player war hand (and/or the dealer war hand) against a community war hand; a community war hand against the player war hand (and/or the dealer war hand); or the like. In such embodiments, a war payout would be issued if the war hand wagered upon outranks the war hand to which it was compared and the war base wager would be collected if the war hand wagered upon is outranked by the war hand to which it was compared.

In another example, multiple war base wagers may be received, with each designating different hands for resolving the war base wager. For example, an option may be offered in which war base wagers may be received on other players' player hands, e.g., the player in seat three may be allowed to place separate war base wagers on the player war hands belonging to players in seats one, two, four, five, and six. In an additional or alternate example, an option may be offered in which a war base wager may be received on one or more community war hands in addition to, or in place of, player war hands. In such optional embodiments, each one of the multiple war base wagers may be resolved based on a separate comparison as discussed in greater detail below.

A method according to an embodiment of the present invention may be conducted using any type of game pieces, including conventional playing cards. It is contemplated that the conventional playing cards may be constituted into any deck constitution, including a conventional fifty-two card poker deck, a truncated deck (such as a Spanish deck), a supplemented deck (such as a conventional poker deck with one or more Jokers added), or any other deck constitution. Additionally, it is contemplated that a method according to the present invention may be conducted using a single deck or multiple decks, and that any quantity of games may be conducted between randomization (e.g., shuffling) of the playing card inventory, including a continuous shuffle.

A player war hand is dealt 604. In an optional embodiment, the player war hand includes a single playing card (or electronic representation thereof) dealt face-up. However, in alternate optional embodiments, it is contemplated that the player war hand could consist of any quantity of playing cards that are dealt face-up or face-down.

A dealer war hand is dealt 606. Again, in an optional embodiment, the dealer war hand includes a single playing card (or electronic representation thereof) dealt face-up. However, in alternate optional embodiments, it is contemplated that the dealer war hand could consist of any quantity of playing cards that are dealt face-up or face-down. The phrase “dealer war hand” should not be interpreted as being limited to a house dealer insofar as the recipient of a “dealer war hand” could be a house dealer, computer-controlled dealer, player-banker, banker (as described in greater detail below), or the like. That is, the “dealer war hand” is dealt to the entity which banks the wagers, i.e., pays winning wagers and collects losing wagers.

As illustrated in FIG. 1, a war portion of a game may be completed prior to dealing any additional playing cards to a player base game hand and/or a dealer base game hand. That is, in the example of FIG. 1, the steps of dealing a player war hand and a dealer war hand may be separated from the steps of dealing a player base game hand and a dealer base game hand. In the example embodiment of FIG. 1, the player base game hand includes the player war hand. Thus, in such an optional embodiment, the player war hand is incorporated into the player base game hand after the war stage of the game is completed. Similarly, in the example embodiment of FIG. 1, the dealer base game hand includes the dealer war hand. Thus, in such an optional embodiment, the dealer war hand is incorporated into the dealer base game hand after the war stage of the game is completed. It is noted that since the dealer war hand is exposed during the war stage of the game, a portion of the dealer base game hand would be known prior to the base game stage of the game. As may be appreciated, this information could advise any decisions made by the player between the war stage and base game stage of the game, such as whether to supplement the base game wager with a portion, or all, of any war payout received.

With continued reference to FIG. 1, the player war hand is compared 608 to the dealer war hand. Using a predetermined ranking system, a determination is made whether to issue 610 a war payout based on the war base wager. In one optional embodiment, the war payout is even money based on the war base wager.

In one optional embodiment, the war base wager is resolved by issuing a war payout if the player war hand outranks the dealer war hand, and collecting the war base wager if the dealer war hand outranks the player war hand. It is contemplated that the rankings may be determined by the ascending values of the playing cards in the player war hand and dealer war hand, e.g., a King outranks cards having a value of Queen or lower. In this regard, it is noted that in an optional embodiment utilizing conventional playing cards, Ace may be treated as the highest ranking playing card or the lowest ranking playing card, depending on the optional embodiment. Additionally, it is contemplated that ties may be handled in any fashion, including being resolved in favor of the dealer war hand (i.e., dealer takes ties), being resolved in favor of the player war hand (i.e., player takes ties), being resolved as a push, or being resolved based on a tiebreaker. It is contemplated that an embodiment employing a tiebreaker may use any procedure to break the tie, including dealing additional playing cards to a player war hand and/or dealer war hand.

In an alternate optional embodiment, the player war hand may consist of multiple playing cards. In one such optional embodiment, the multiple playing cards of the player war hand are each separately compared to the dealer war hand. Thus in one example, the player war hand consists of two playing cards and the dealer war hand consists of one playing card. Each playing card of the player war hand is compared to the single playing card of the dealer war hand. If both the playing cards of the player war hand outrank the single playing card of the dealer war hand, the war base wager is rewarded. If the single playing card of the dealer war hand outranks both playing cards of the player war hand, the war base wager is collected. Thus, in one such example, a player war hand of 7 [symbol] K [symbol] would outrank a dealer war hand of 6 [symbol] because each playing card of the player war hand outranks the dealer war hand. Conversely, a player war hand of 2⋄ 5 [symbol] would be outranks by a dealer war hand of 6 [symbol] because each playing card of the player war hand is outranked by the dealer war hand. The case where only one of the playing cards of the player war hand outranks the dealer war hand, while the other playing card of the player war hand is outranked by the dealer war hand may be handled in any fashion. For example, in one optional embodiment, such an outcome may be a push, i.e., the war base wager may be returned. In alternate optional embodiments, such outcomes may be treated as a player winning outcome, e.g., a payout may be issued, or as a player losing outcome, e.g., the war base wager may be collected. Similarly, tied cards may be handled in any fashion, e.g., a card of the player war hand is equal to the dealer war hand, including a player-winning outcome, a dealer-winning outcome, or a push. Thus, in one such optional embodiment, if both playing cards of a player war hand outrank a dealer war hand, a payout is issued; if both playing cards of a player war hand tie, or are outranked by, a dealer war hand, the war base wager is collected; if one playing card of the player war hand outranks a dealer war hand and the other playing card of the player war hand ties, or is outranked by, a dealer war hand, the war base wager is returned.

It is likewise contemplated that the dealer war hand may include multiple playing cards. For example, a war stage of a game may be conducted in which a player war hand must outrank multiple playing cards of a dealer war hand. In one optional embodiment, the player war hand may be required to outrank each playing card of the dealer war hand to outrank the dealer war hand. In one such example, a player war hand consisting of a single playing card outranks a dealer war hand consisting of two playing cards when the single playing card of the player war hand outranks each playing card of the dealer war hand.

In another optional embodiment, the player war hand and/or the dealer war hand may consist of multiple playing cards, with only one (or more) specified playing cards used in the war stage of a game. For example, a player war hand may be dealt multiple playing cards and a dealer war hand may be dealt multiple playing cards, with the highest value playing card selected from the playing cards dealt to each hand for use in the war stage of a game. Thus, in one such example, two playing cards may be dealt to each of a player war hand and a dealer war hand, and the highest ranking playing card from the player war hand compared to the highest ranking playing card of the dealer war hand to resolve the war base wager. As may be appreciated, any characteristic may be used in selecting a playing card from a war hand for use in a war stage of a game. Thus, one optional embodiment may include selecting the lowest playing card, or selecting a playing card of a particular suit, color, or the like, for comparison in a war stage of a game. Moreover, as discussed above, a war stage of a game may include multiple comparisons, e.g., the highest playing card of a dealer war hand compared to each of two playing cards from a player war hand.

It is further contemplated that the war stage of a game may include multiple war base wagers for each player war hand, with each war base wager resolved by a different comparison. Thus, in one such optional embodiment, a player war hand may include a single playing card and a dealer war hand may include multiple playing cards. In one such optional embodiment, separate war base wagers may be received to correspond to each playing card of the dealer war hand. The multiple war base wagers may then be resolved by comparing the single playing card of the player war hand to each of the multiple playing cards of the dealer war hand corresponding to a war base wager. It is contemplated that such an optional embodiment may be likewise conducted using a multi-card player war hand against a single-card dealer war hand, or a multi-card player war hand against a multi-card dealer war hand.

In another optional embodiment, the war stage of the game may be characterized as a match game. For example, in one optional embodiment, the player war hand may consist of multiple playing cards and a first stage of the game may consist of a comparison between the playing cards of the player war hand. Thus, in one such example, a player war hand may consist of two playing cards, and the war base wager may be rewarded if the two playing cards of the player war hand match one another in a predefined fashion, e.g., value, rank, suit, color, and/or the like. If the two playing cards of the player war hand do not match in the predefined fashion, the war base wager is collected. It is also contemplated that the present invention could be conducted in the converse manner, with the war base wager rewarded for non-matching playing cards and collected for matching playing cards.

In another example, the player war hand may be compared to the dealer war hand. If the playing card(s) of the player war hand match the playing card(s) of the dealer war hand in a predefined fashion, e.g., value, rank, suit, color, and/or the like, the war base wager is rewarded. If the playing card(s) of the player war hand do not match the playing card(s) of the dealer war hand in the predefined fashion, the war base wager is collected. It is also contemplated that the present invention could be conducted in the converse manner, with the war base wager rewarded for non-matching war hands and collected for matching war hands.

In one optional embodiment, the war payout is issued to the player when the war base wager correctly designates the higher (or highest) ranking war hand. In an optional embodiment, the player may choose whether to collect the war payout or add at least a portion of the war payout to the player's base game wager. Thus, in such an optional embodiment, a player may elect to either collect the war payout or add at least a portion of the war payout to the base game wager. In an alternate optional embodiment, the war payout is automatically added to the base game wager, i.e., no election is received to cap the base game wager.

In the optional embodiment illustrated in FIG. 1, it is contemplated that an election is received 612 from a player whether to supplement the base game wager with the winnings from the war stage of the game. In the event that a player elects to cap the base game wager, at least a portion of the war payout is added 616 to the base game wager. If the player elects not to cap the base game wager, the war payout is collected by the player. In an optional embodiment, the war base wager is collected by the player regardless of whether the player elects to cap the base game wager.

As alluded to above, it is contemplated that the timing of the election to cap the base game wager with the war payout, if any, may vary depending on the embodiment. In one optional embodiment, the election to cap the base game wager may occur after the exposure of the player war hand and the dealer war hand which will comprise a portion of the player base game hand and dealer base game hand, respectively. In such an optional embodiment, the election whether to cap a base game wager occurs with knowledge of at least a portion of the player base game hand and at least a portion of the dealer base game hand. It is contemplated that in alternate optional embodiments, the player war hand is independent of the player base game hand and the dealer war hand is independent of the dealer base game hand and, consequently, the decision to supplement, i.e., cap, the base game wager is made without any knowledge of the player base game hand and/or the dealer base game hand.

It is contemplated that house rules may dictate whether an election to cap a base game wager applies to the entire war payout or only a portion of a war payout. That is, in one optional embodiment, an election to cap, i.e., supplement, the base game wager will result in adding a fixed amount of any war payout to the base game wager. For example, in one optional embodiment, an election to cap the base game wager with the war payout results in the entire war payout being added to the base game wager. It is noted that other examples may include embodiments in which an election to cap the base game wager results in a fixed portion (e.g., half) of the war payout being added to the base game wager.

In another optional embodiment, the election may include both whether to cap the base game wager and the quantity of the war payout that caps the base game wager. Thus, in one such example, a player may elect to cap the base game wager with any player-selected amount of the war payout. For example, a player may elect to cap the base game wager with ten percent of the war payout and remove the remainder of the war payout to the player's bankroll.

After the war stage of the game is concluded, and any elections to supplement the base game wagers are received, the base game is conducted. In an optional embodiment, as discussed above, this includes dealing 614 a player base game hand and dealing 618 a dealer base game hand that include the player war hand (or a portion thereof) and dealer war hand (or a portion thereof), respectively. Thus, in such an optional embodiment, the election to cap the base game wager is made with at least partial knowledge of the player base game hand and dealer base game hand since the player war hand and dealer war hand are exposed prior to the election.

Through the course of the base game, the base game wagers, including any supplement from the war payout, if any, are resolved 620. In an optional embodiment, supplemented base game wagers are resolved as a unit, i.e., the base game wager placed at the beginning of the game and the supplement from the war payout are treated as a single unit that win or lose based on the outcome of the base game. Specifically, if the player base game hand is a winning hand, a base game payout may be issued based on the sum of the base game wager and the supplement from the war payout, if any. If the player base game hand is a losing hand, the base game wager and any supplement from the war payout would be collected. Ties may be resolved in favor of the dealer, the player, or may be resolved as a push.

A number of examples are now described. It should be noted that these examples are merely illustrative of how the present invention may be applied to a blackjack game, a baccarat game, and a poker game (or poker variant), and should not be interpreted as limiting the application of the present invention to these particular games.

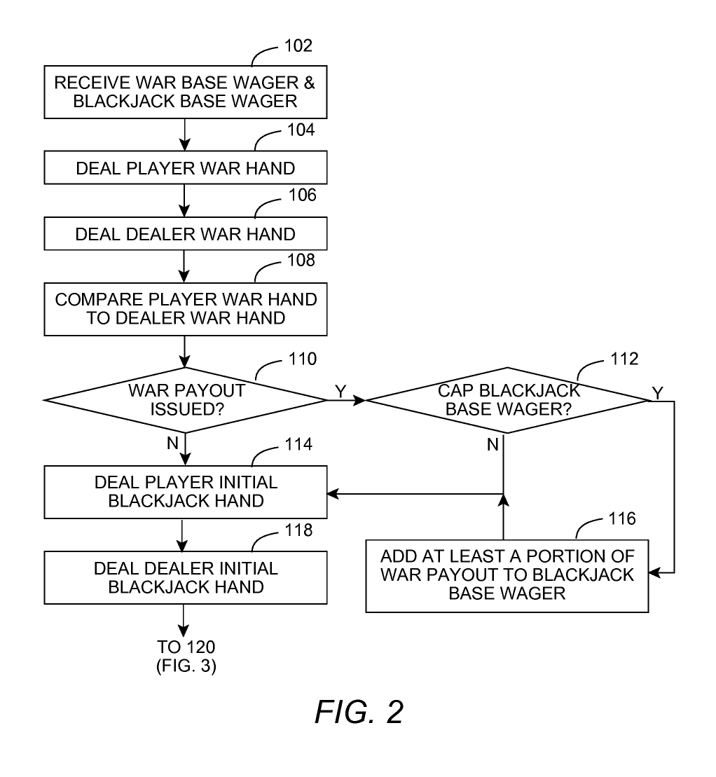

As illustrated in FIGS. 2-4, the present invention may be applied to the game of blackjack. In the illustrated example, a blackjack base wager and a war base wager are received 102. In an optional embodiment, the blackjack base wager and war base wager are received at the beginning of a game, e.g., prior to dealing or exposing any playing cards. As noted above, the relative sizes of the blackjack base wager and war base wager may be determined by the operator. In one such optional embodiment, the blackjack base wager and war base wager may be required to be the same size. In alternate optional embodiments, the blackjack base wager and war base wager may have any other proportional relationship or no proportional relationship (e.g., the blackjack base wager and war base wager merely need to fall within predefined table limits).

As noted above, in one optional embodiment, the war base wager may be resolved solely based on the player war hand outranking the dealer war hand and, consequently, does not require a designation of how the war base wager is resolved. For example, in one optional embodiment, a war base wager may be accompanied by a designation of either the player war hand or the dealer war hand for resolution of the war base wager. In such an example, a war base wager designating the player war hand would be paid if the player war hand outranks the dealer war hand and collected if the player war hand is outranked by the dealer war hand; whereas a war base wager designating the dealer war hand would be paid if the dealer war hand outranks the player war hand and collected if the dealer war hand is outranked by the player war hand.

A player war hand is dealt 104 and a dealer war hand is dealt 106. In an optional embodiment, the player war hand and dealer war hand each include a single playing card (or electronic representation thereof) dealt face-up, although it is contemplated that the player war hand and/or the dealer war hand could consist of any quantity of playing cards that are dealt face-up or face-down.

As illustrated in FIG. 2, a war portion of a game may be completed prior to dealing any additional playing cards to an initial player blackjack hand and/or an initial dealer blackjack hand. That is, in the example of FIG. 2, the steps of dealing a player war hand and a dealer war hand may be separated from the steps of dealing an initial player blackjack hand and an initial dealer blackjack hand. In the example embodiment of FIG. 2, the initial player blackjack hand may include the player war hand. That is, in one example, an initial player blackjack hand includes two playing cards. One of the playing cards of the initial player blackjack hand is dealt 104 first and is designated the player war hand. The second playing card of the initial player blackjack hand is dealt 114 after the resolution of the war base wager, and the combination of the two playing cards constitutes the initial player blackjack hand. Thus, in one such example, the playing card 80⋄, designated the player war hand, may be dealt. After resolution of the war base wager, an additional playing card J [symbol] may be dealt, such that the initial player blackjack hand consists of the combination of playing cards J [symbol] 8⋄. In another example according to the optional embodiment of FIG. 2, the player war hand may be dealt 104, and the initial player blackjack hand may be dealt 114 separate and independent from the player war hand without retaining any of the playing cards from the player war hand for inclusion in the initial player blackjack hand. Thus, in one such example, the playing card A [symbol] may be dealt to a player war hand, which is not carried over to the initial player blackjack hand, but rather two previously undealt playing cards are dealt to the initial player blackjack hand.

Similarly, the initial dealer blackjack hand may include the dealer war hand. That is, in one example, an initial dealer blackjack hand includes two playing cards, with one playing card dealt 106 to a dealer war hand, and a second playing card dealt 118 to be combined with the playing card of the dealer war hand to form a two-card initial dealer blackjack hand. In such an optional embodiment, the card dealt to the dealer war hand would function as the exposed card of the two-card initial dealer blackjack hand, i.e., the second playing card dealt to be combined with the dealer war hand would be dealt face-down or unexposed. Alternatively, the dealer war hand may be dealt separate and independent from the initial dealer blackjack hand without carrying over any playing cards from the dealer war hand for inclusion in the initial dealer blackjack hand. In such an optional embodiment, exposing one card of the initial dealer blackjack hand may occur when the initial dealer blackjack hand is dealt, or may be delayed until after the war base wager is resolved and a decision to cap the blackjack base wager is received (as discussed in greater detail below). It is contemplated that the player hands may be dealt using the same procedure as the dealer hand. Alternatively, the player hands may be dealt differently from the dealer hands, e.g., the initial player blackjack hand may include the player war hand whereas the initial dealer blackjack hand excludes the dealer war hand, or vice versa.

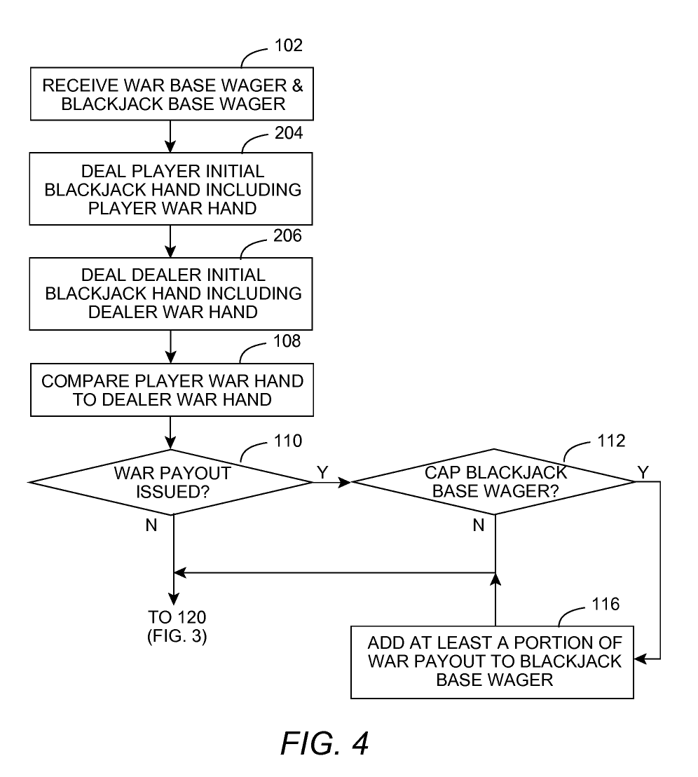

In another optional embodiment, illustrated in FIG. 4, an initial player blackjack hand is dealt 204, which includes a player war hand. Likewise, an initial dealer blackjack hand is dealt 206, which includes a dealer war hand. For example, in an optional embodiment two playing cards are dealt, with one playing card being designated the player war hand, and the combination of the two playing cards constituting the initial player blackjack hand. In essence, the optional embodiment of FIG. 4 includes dealing both the player war hand and initial player blackjack hand prior to resolving the war base wager, whereas the optional embodiment of FIG. 2 includes dealing only the player war hand prior to resolving the war base wager. This distinction is discussed in greater detail below. It is noted that the designation of the player war hand may be determined by chance (e.g., the first, or second, playing card dealt to the initial player blackjack hand is designated the player war hand), by the player (e.g., the player selects a playing card from the initial player blackjack hand to be the player war hand), or by house rules (e.g., the higher or lower playing card from the initial player blackjack hand is designated the player war hand).

Referring generally to FIGS. 2 and 4, the player war hand is compared 108 to the dealer war hand. Using a predetermined ranking system, a determination is made whether to issue 110 a war payout based on the war base wager. In one optional embodiment, the war payout is even money based on the war base wager. In the optional embodiment illustrated in FIG. 2, a ranking system is used in which Ace is the lowest ranking playing card such that the playing cards are, in ascending order, Ace, 2, 3, 4, 5, 6, 7, 8, 9, 10, Jack, Queen, and King, and all ties are resolved in favor of the dealer war hand. However, as discussed above, alternate ranking systems and/or tie-breaking rules may be used.

In one optional embodiment, the war payout, if any, is issued to the player. In another optional embodiment, an election is received whether to issue the war payout, if any, to the player or add at least a portion of the war payout, if any, to the blackjack base wager. In yet another optional embodiment, the war payout is automatically added to the blackjack base wager, i.e., no election is received to cap the blackjack base wager.

In the optional embodiments illustrated in FIGS. 2 and 4, it is contemplated that an election is received 112 from a player whether to supplement the blackjack base wager with the winnings from the war portion of the game. In the event that a player elects to cap the blackjack base wager, at least a portion of the war payout is added 116 to the blackjack base wager. As alluded to above, it is contemplated that the timing of the election to cap the blackjack base wager with the war payout, if any, may vary depending on the embodiment. In one optional embodiment, the election to cap the blackjack base wager with all, or a portion of, the war payout may occur prior to exposure of a card of the initial dealer blackjack hand or dealing of the initial player blackjack hand. In such an optional embodiment, no information about the player or dealer blackjack hands would be known when the election is received. In another optional embodiment, the election to cap the blackjack base wager may occur after the initial player blackjack hand (or a portion thereof) is dealt and exposed, but before any playing cards of the initial dealer blackjack hand are exposed (or dealt). In yet another optional embodiment, the election to cap the blackjack base wager may occur after exposure of one playing card of the initial dealer blackjack hand is exposed, but before the initial player blackjack hand is dealt. In yet another optional embodiment, the election to cap the blackjack base wager may occur after exposure of one playing card of the initial dealer blackjack hand is exposed and the initial player blackjack hand (or a portion thereof) is dealt and exposed. In the latter optional embodiment, for example, a face-up card may be dealt to the player war hand and a face-up card may be dealt to be combined with the player war hand to form the initial player blackjack hand. Similarly, a face-up card may be dealt to the dealer war hand and a face-down card may be dealt to be combined with the dealer war hand to form the initial dealer blackjack hand. In this manner, the election whether to cap a blackjack base wager occurs with knowledge of the complete initial player blackjack hand and one of the two playing cards of the initial dealer blackjack hand. As discussed above, alternate optional embodiments would require the decision to cap a blackjack base wager to be made with less information about the initial player blackjack hand and/or the initial dealer blackjack hand.

As noted above, the house rules may determine how much of the war payout is added to the blackjack base wager in the event that a war payout is received and the player elects to supplement, e.g., cap, the blackjack base wager. In one optional embodiment, the decision to supplement the blackjack base wager results in the addition of all the war payout to the blackjack base wager. However, in alternate optional embodiments, a different fixed quantity or a player-selected quantity of the war payout may be added to the blackjack base wager when the player elects to supplement the blackjack base wager.

In one optional embodiment, a subsequent stage of the game is conducted to resolve the blackjack base wager, including any supplement from a war payout. This stage of the game includes an initial player blackjack hand. In one optional embodiment illustrated in FIG. 2, an initial player blackjack hand is dealt 114 after the decision to cap the blackjack base wager is received 112. As noted above, the step of dealing an initial player blackjack hand in the embodiment of FIG. 2 may include dealing a second playing card which is used in combination with the player war hand to form an initial player blackjack hand. That is, in such an optional embodiment, the initial player blackjack hand incorporates the player war hand. In alternate optional embodiments, the initial player blackjack hand may incorporate only a portion of the player war hand (such as when the player war hand includes multiple playing cards). Alternatively, the step of dealing an initial player blackjack hand in the embodiment of FIG. 2 may include removing the player war hand from play and dealing an initial player blackjack hand that is independent of the player war hand.

In the optional embodiment of FIG. 4, an initial player blackjack hand is dealt 204 prior to the decision to cap the blackjack base wager being received 112. More specifically, in the optional embodiment of FIG. 4, the initial player blackjack hand is dealt 204 to include the player war hand. However, it is contemplated that in alternate optional embodiments, the initial player blackjack hand dealt at the commencement of the game may be separate and independent of the player war hand dealt at the commencement of the game.

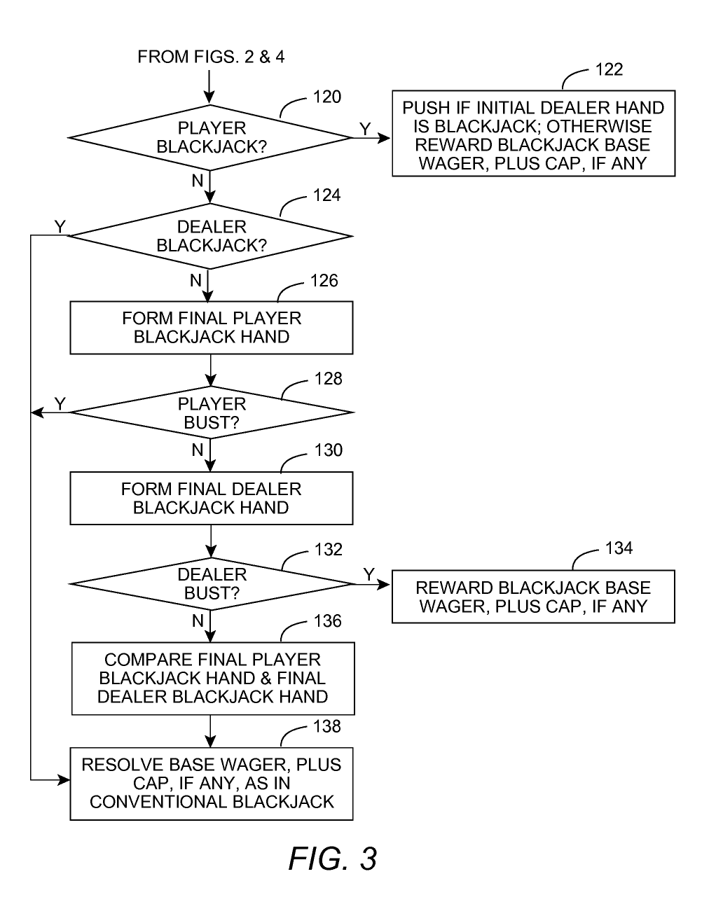

Similarly, an initial dealer blackjack hand is dealt 206. As noted above, the step of dealing an initial dealer blackjack hand in the embodiment of FIG. 2 may include dealing a second playing card which is used in combination with the dealer war hand to form an initial dealer blackjack hand. That is, in such an optional embodiment, the initial dealer blackjack hand incorporates the dealer war hand. In alternate optional embodiments, the initial dealer blackjack hand may incorporate only a portion of the dealer war hand (such as when the dealer war hand includes multiple playing cards). Alternatively, the step of dealing an initial dealer blackjack hand in the embodiment of FIG. 1 may include removing the dealer war hand from play and dealing an initial dealer blackjack hand that is independent of the dealer war hand. In the optional embodiment of FIG. 3, the initial dealer blackjack hand is dealt 206 to include the dealer war hand. However, it is contemplated that in alternate optional embodiments, the initial dealer blackjack hand dealt at the commencement of the game may be separate and independent of the dealer war hand dealt at the commencement of the game.

In one optional embodiment, a conventional blackjack game is conducted after resolving the war base wager. For example, referring generally to FIG. 3, in one optional embodiment, a determination is made 120 whether the initial player blackjack hand includes a blackjack, i.e., a two-card hand with a sum equal to a target value of twenty-one. In determining the sum of the values of the playing cards in a hand, each numbered playing card has a value equal to its face value, Jack, Queen, and King have a value equal to ten, and Ace has a value of one or eleven, as determined by the other playing cards in the hand. Thus, a blackjack holding, also referred to as a “twenty-one” or a “natural,” is a two-card hand containing an Ace and a ten-value playing card. If the initial player blackjack hand is a blackjack, the blackjack base wager, including any cap from the war payout, if any, may be immediately resolved, with a blackjack payout issued 122 if the initial dealer blackjack hand is not a blackjack. Optionally, a blackjack payout for an initial player blackjack hand containing a blackjack is greater than even money, e.g., 3:2 or 6:5, depending on the optional embodiment.

In an optional embodiment, a push occurs (i.e., the blackjack base wager including any cap from the war payout, if any, is returned) if the initial player blackjack hand and the initial dealer blackjack hand both contain a blackjack. In an alternate optional embodiment, situations in which both the initial player blackjack hand and initial dealer blackjack hand both contain a blackjack may be resolved in favor of the house, i.e., dealer wins ties or in favor of the player, i.e., player wins ties. In further optional embodiments, ties may be broken using a predefined tie-breaking procedure.

If the initial player blackjack hand is not a blackjack, a determination 124 is made whether the initial dealer blackjack hand contains a blackjack, e.g. a two-card hand containing an Ace and a ten-value playing card. In an optional embodiment, if the initial dealer hand is a blackjack, the war base wager including any cap from the war payout, if any, may be collected for each initial player blackjack hand that is not also a blackjack. Play may be terminated for those players whose blackjack base wagers (including any cap) were collected. It is contemplated that, in an optional embodiment, an insurance wager may be offered when an exposed playing card of the initial dealer blackjack hand is an Ace. In an optional embodiment, such an insurance wager may operate in a conventional manner, with the insurance wager paid and the blackjack base wager (including any cap) collected if the initial dealer blackjack hand contains a blackjack.

If the initial dealer blackjack hand does not include a blackjack, a final player blackjack hand is formed 126 for each initial player blackjack hand not containing a blackjack. In an optional embodiment, final player blackjack hands are formed using the options available in conventional blackjack. For example, the options of hitting (i.e., receiving an additional playing card to the player hand), standing (i.e., ceasing to add playing cards to the player hand and designating the then-existing player hand as the final player blackjack hand), splitting a pair (i.e., placing an additional wager to form an additional initial player blackjack hand with each member of the pair constituting the basis for each initial player blackjack hand in combination with a newly dealt playing card), and doubling down (i.e., placing an additional blackjack wager to receive a single additional playing card to the player hand). It is contemplated that these options may be conducted in a conventional manner, or may be limited in some fashion to accommodate a desired house edge in the blackjack portion of the game. For example, the quantity of times a player may split, the player hands eligible for doubling down, whether a player may double down after splitting a hand, or other aspects of these options, may be limited in various optional embodiments.

In an optional embodiment, additional options, which are less common in conventional blackjack, such as surrendering a player hand, may be offered as well. It should also be noted that side action (e.g., side bets, bonus bets, or the like) may be offered along with the blackjack base wager in various optional embodiments.

If, in the course of forming a final player blackjack hand, the sum of the values of the playing cards in the player hand exceeds the target value of twenty-one, the player hand is deemed to “bust.” For example, if a player hand contains playing cards with a sum of thirteen, and the player hand hits and obtains a ten-value playing card, that player hand is deemed to “bust.” When a player hand busts 128, the blackjack base wager including any cap may be resolved 138 in a conventional manner with collection of the blackjack base wager including any cap. Further play in the game is terminated for any player hand that busts.

After each initial player blackjack hand is formed 126 into at least one final blackjack hand (keeping in mind that where splitting is permitted, an initial player blackjack hand may form multiple final player blackjack hands), the initial dealer blackjack hand is formed 130 into a final dealer blackjack hand. In an optional embodiment, the formation of a final dealer blackjack hand is determined according to house rules, insofar as there exists no discretion in the formation of the final dealer blackjack hand. For example, in conventional blackjack, a common house rule is that the dealer hand must hit until the sum of the values of the playing cards in the dealer hand greater than, or equal to, seventeen. In a further optional embodiment, a dealer hand may be required to hit when the sum of the values of the playing cards in the dealer hand equal seventeen when any Ace within the dealer hand is counted as eleven. Such a rule is often referred to as a “dealer must hit soft 17” rule.

If, in the course of the final dealer blackjack hand, the sum of the values of the playing cards in the dealer hand exceeds the target value of twenty-one, the dealer hand is deemed to “bust.” When a dealer hand busts 132, the blackjack base wager including any cap may be resolved in a conventional manner by issuing 134 a reward based on the blackjack base wager including any cap. In an optional embodiment, such a blackjack payout may be even money based on the blackjack base wager including any cap.

When neither the dealer hand nor the player bust, the final dealer blackjack hand and final player blackjack hand are compared 136 and the blackjack base wager, including any cap, is resolved 138 in a conventional manner. More specifically, the sum of the values of the playing cards in the final player blackjack hand is compared to the sum of the values of the playing cards in the final dealer blackjack hand and the target value of twenty-one. If the final player blackjack hand sum is closer to twenty-one than the final dealer blackjack hand sum is, a blackjack payout is issued based on the blackjack base wager including any cap. In an optional embodiment, the blackjack payout is even money. Conversely, if the final dealer blackjack hand sum is closer to twenty-one than the final player blackjack hand sum is, the blackjack base wager, including any cap, is collected, i.e., lost. Ties may be resolved in any manner. For example, in one optional embodiment, ties are resolved as a push and the blackjack base wager, including any cap, is returned. In alternate optional embodiments, ties may be resolved in favor of the house, i.e., dealer wins ties, resolved in favor of the player, i.e., player wins ties, or broken using a predetermined tiebreaker procedure.

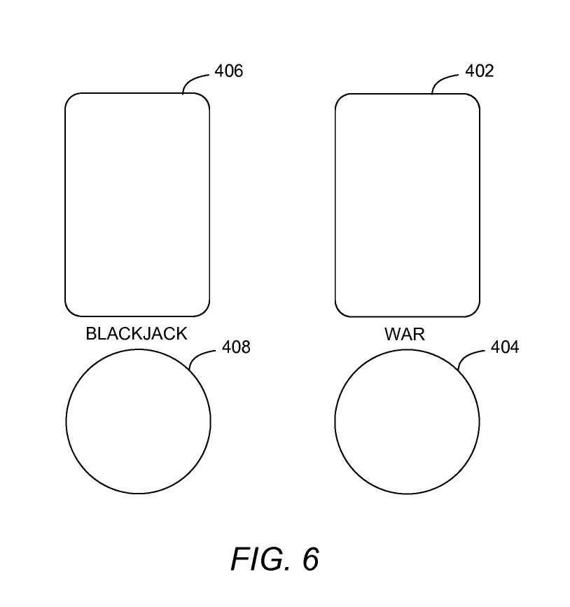

In use, a method according to an embodiment of the present invention may be carried out on a live table. In one such optional embodiment, a table layout may include a player area, such as that illustrated in FIG. 6. In the optional embodiment illustrated in FIG. 6, a player area includes a war base wager area 404 and a blackjack base wager area 408. In an optional embodiment, a war base wager area 404 receives the war base wager and the blackjack base wager area 408 receives the blackjack base wager. The wager amounts may be designated in any manner, including as currency, coins, gaming chips or gaming checks, credits, markers, or the like. In such an optional embodiment, wagers may be received when a wager amount is placed into the corresponding wager area. Similarly, payouts may be issued by placing a payout amount adjacent to the wager in or near the corresponding wager area. In an optional embodiment, a blackjack base wager is “capped” with the war payout (or a portion thereof) by placing the war payout (or a portion thereof) into the blackjack base wager area 408 adjacent or on the blackjack base wager. Optionally, the cap amount is placed into the blackjack base wager area 408 by a house dealer, player-banker, or the like such that the player does not handle the cap amount. For example, in one optional embodiment, the election to cap the blackjack base wager is simply indicated to a house dealer, player-banker, or the like and the war payout (or a portion thereof) is issued directly into the blackjack base wager area 408 by the house dealer, player-banker, or the like.

A player area may also include a player war hand area 402 and a player blackjack hand area 406. In an optional embodiment in which the initial player blackjack hand does not include the player war hand, a single card may be dealt to the player war hand area 402 and two cards (constituting the initial player blackjack hand) may be dealt to the player blackjack hand area 406. In an optional embodiment in which the initial player blackjack hand includes the player war hand, a single card may be dealt to the player war hand area 402 and a single card may be dealt to the player blackjack hand area 406, such that the single card in the player war hand area 402 constitutes the player war hand, and the combination of the single card in the player war hand area 402 and the single card in the player blackjack hand area 406 constitute the initial player blackjack hand.

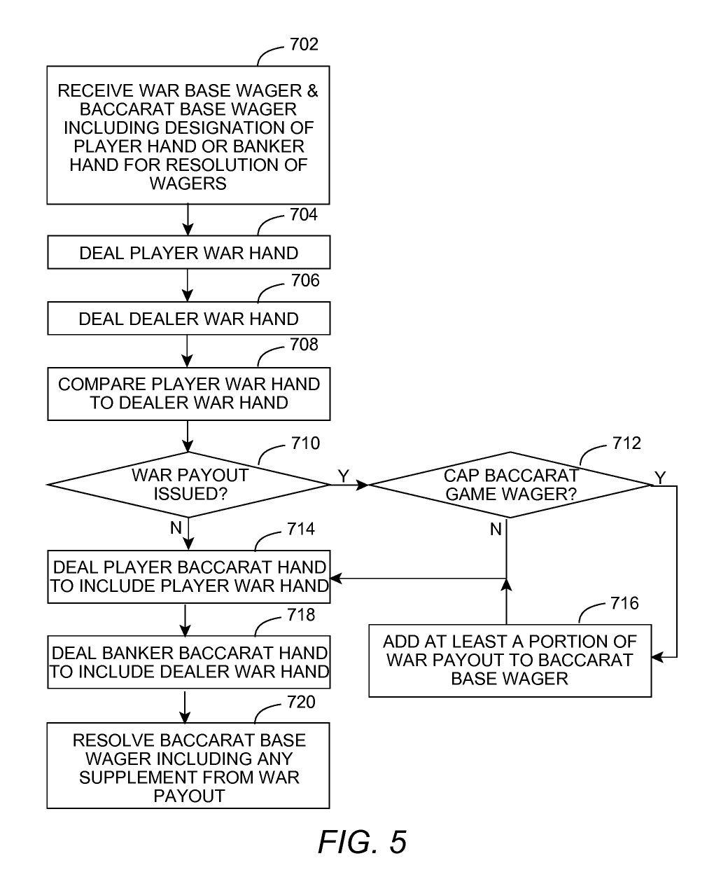

The present invention may be applied to any base game. For example, in another optional embodiment illustrated in FIG. 5, the present invention may be applied to the base game of Baccarat. In one such optional embodiment, the present invention may be applied to a more-or-less conventional Baccarat game in which the Player hand and Banker hand are both community hands. In an alternate optional embodiment, the present invention may be applied to a modified Baccarat game in which each player is dealt a separate player hand, which is compared to a single Banker hand.

In either case, a war base wager and a baccarat base wager are received 702. In one optional embodiment, the war base wager and baccarat base wager are received prior to dealing any playing cards. As may be appreciated, in conventional Baccarat, the baccarat base wager may designate either the Banker hand or the Player hand for resolution of the baccarat base wager. In an optional embodiment, the war base wager may likewise designate either the Banker hand or the Player hand for resolution of the war base wager. In an optional embodiment, a player's war base wager may be required to designate the same hand as the player's baccarat base wager. In an alternate optional embodiment, the player may be allowed to place the player's baccarat base wager and war base wager on different hands.

A player war hand is dealt 704 (again, the player war hand may be a community hand or may be a hand personal to each player). In one optional embodiment, the player war hand consists of a single playing card, although as discussed above, the player war hand may consist of multiple playing cards. A banker war hand is likewise dealt 706. Again, the banker war hand may consist of a single playing card or multiple playing cards, depending on the optional embodiment.

While the example provided herein describes a single-card player war hand against a single-card banker war hand, it should be noted that any of the variations described above may be utilized in this optional embodiment applied to Baccarat. Proceeding with the example, the player war hand is compared 708 to the banker war hand. If the player war hand outranks the banker war hand in whatever fashion the relative rankings are defined, a war payout is issued 710 based on the war base wager. The relative rankings may be defined in any manner, including conventional poker rankings, e.g., 2, 3, 4, 5, 6, 7, 8, 9, 10, J, Q, K, A in ascending order; a modified poker ranking in which ace is the lowest ranking card, e.g., A, 2, 3, 4, 5, 6, 7, 8, 9, 10, J, Q, K in ascending order; a modular 10 ranking in which all ten value cards equal zero, e.g., zero, A, 2, 3, 4, 5, 6, 7, 8, 9 in ascending order; or any other ranking system.

As discussed above, the baccarat base wager may be supplemented with some or all of the war payout, depending on the house rules. In one such optional embodiment, an election is received from the player to either supplement 712 the baccarat base wager with the entire war payout or collect both the war payout and the war base wager by the player. In the event that an election is received to supplement the baccarat base wager with the war payout, the war payout is added 716 to the baccarat base wager and the war base wager is collected by the player. As may be appreciated, the election to supplement the baccarat base wager with the war payout may be advised by the exposed banker war hand which may form at least part of the banker baccarat hand as discussed below. In an optional embodiment, the baccarat base wager may designate either the player baccarat hand or the banker baccarat hand for resolution of the baccarat base wager. In one such optional embodiment, the supplement will be added to the baccarat base wager without changing the hand wagered upon. That is, when a baccarat base wager designates “Player,” the war payout may be used to supplement the amount already wagered on “Player,” but may not be used to place a separate wager on “Banker.” Similarly, when a baccarat base wager designates “Banker,” the war payout may be used to supplement the amount already wagered on “Banker,” but may not be used to place a separate wager on “Player.” Thus, in such an optional embodiment, the war payout of such an optional embodiment may only be used to supplement an already-placed wager rather then placing a different or new wager.

Conversely, if the banker war hand outranks the player war hand, the war base wager is collected by the game operator, i.e., the war base wager is lost by the player. In such a case, no election to supplement the baccarat base wager because there is no war payout to add to the baccarat base wager.

A player baccarat hand is dealt 714 and a banker baccarat hand is dealt 718. Similar to the example directed to blackjack, the banker war hand and/or the player war hand may be incorporated into the banker baccarat hand and/or player baccarat hand, respectively. That is, the present invention includes both the situation in which the player war hand is integrated with, or separate from, the player baccarat hand. Likewise, the present invention includes both the situation in which the banker war hand is integrated with, or separate from, the banker baccarat hand.

Thus, in an optional embodiment of the present invention, an election is received to supplement baccarat base wagers with war payouts, if any. After the election is received, a player baccarat hand is formed. In one optional embodiment, the player baccarat hand is formed in a conventional manner using conventional Baccarat draw rules described above. After a player baccarat hand is formed, a banker baccarat hand is formed. Again, the banker baccarat hand may be formed in a conventional manner using conventional Baccarat draw rules described above. The player baccarat hand is compared to the banker baccarat hand and the baccarat base wagers, including any war payouts that were added to the baccarat base wagers after the war stage of the game, are resolved 720. That is, if no war payout was added to a baccarat base wager, either because no war payout was issued or because an election was received not to supplement the baccarat base wager, the baccarat base wager is resolved based on the comparison between the player baccarat hand and the banker baccarat hand to the target value. Conversely, if some or all (depending on the optional embodiment) of a war payout was added to a baccarat base wager after the war stage of the game was completed, the baccarat base wager plus the war payout supplement are resolved, together, based on a comparison between the sum of the values of the playing cards, modulo ten, in the player baccarat hand and the sum of the values of the playing cards, modulo ten, in the banker baccarat hand to the target value. That is, in one such optional embodiment, once some or all of the war payout is added to the baccarat base wager, the entire amount (i.e., the baccarat base wager plus the supplement) is won or lost as a unit. In an optional embodiment, a designation is received to identify which baccarat hand is utilized to resolve the baccarat base wager (plus any supplement). If the baccarat hand designated for resolution of a baccarat base wager outranks the other baccarat hand, a baccarat payout based on the baccarat base wager plus any supplement is issued. Conversely, if the baccarat hand designated for resolution of a baccarat base wager fails to outrank the other hand, the baccarat base wager plus any supplement is collected. In an optional embodiment, ties may be resolved in favor of the house. In a further optional embodiment, a baccarat base wager may designate a tie outcome, with such a wager being paid in the event that the player baccarat hand ties the dealer baccarat hand.

As noted above, the present invention may be applied to any base game. For example, the present invention may be applied to poker (or poker variants) by receiving a war base wager and a poker base wager. The example below is directed to a house-banked carnival game based on poker or a variant of poker, in which a player plays against the house (represented by a player hand against a dealer hand). However, it is contemplated that the present invention may be applied to a player-banked game based on poker or variant of poker, in which a player plays against other players (represented by a player hand against other player hands. Thus, while the example below uses the terms “dealer war hand” and “dealer poker hand,” it should be understood that the player war hand and player poker hand could be played against one or more other player war hands and one or more player poker hands.

A player war hand and a dealer war hand are dealt. As discussed above, the quantity of playing cards in the player war hand and dealer war hand may vary depending on the optional embodiment, but in one optional embodiment the player war hand and dealer war hand each include a single playing card.

The player war hand and dealer war hand are compared. In an optional embodiment, the player war hand and dealer war hand are compared strictly on the values of the single playing card in each war hand. In another optional embodiment in which the player war hand and dealer war hand include multiple playing cards, the multiple playing cards of one war hand may be compared singly, or in combination, to the playing cards of the other war hand. It is contemplated that when each war hand includes a combination of playing cards, the combination may be evaluated based on the sum of the playing card values within the war hand, the highest playing card value within the war hand, the poker hand formed by the cards in the war hand, or any other measure of the combination of playing cards in the war hand.

If the player war hand outranks the dealer war hand, a war payout is issued. Again, as discussed above, when a war payout is issued, in one optional embodiment the war payout may be collected by the player along with the war base bet or the player may elect to supplement the poker base wager with at least a portion of the war payout. As previously described, the amount of the war payout that may be added to the poker base wager may be predefined (e.g., all of the war payout, half of the war payout, or the like) or may be selected by the player.

After the war base wagers are resolved, and any elections to cap the poker base wagers are received, the player poker hand and the dealer poker hand are dealt (or exposed, if previously dealt). In an optional embodiment, the player poker hand incorporates the player war hand (or a portion thereof) and the dealer poker hand incorporates the dealer war hand (or a portion thereof).

The poker base game (which may include poker or a variation thereon), is conducted to resolve each poker base wager plus any supplement from the war payouts. For example, in one optional embodiment, the poker base game may include one or more betting rounds as cards are dealt to the player poker hand, dealer poker hand, and/or a community hand, then a comparison of the player poker hand to the dealer poker hand. In the event that the player poker hand outranks the dealer poker hand, a poker payout is issued based on the poker base wager plus any supplement from the war payout. In the event that the dealer poker hand outranks the player poker hand, the poker base wager plus any supplement from the war payout is collected. As discussed above, ties may be broken or resolved in any manner, including as “dealer takes ties,” “player takes ties,” or a push.

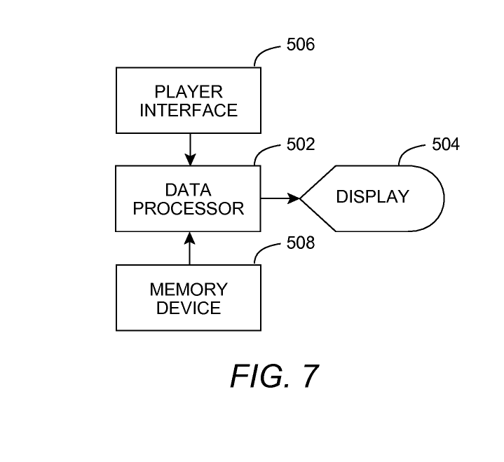

As illustrated in FIG. 7, a method according to the present invention may also be conducted on an electronic device. The form of the electronic device may vary depending on the embodiment. For example, the electronic device may include an electronic gaming table, electronic table system, electronic gaming machine, slot machine, video game machine, gaming console, mobile phone, tablet device, personal computer, kiosk, or the like. In one such example, an electronic device could include a data processor 502. The data processor 502 may take any form, including a conventional computer processor. The data processor 502 is in communication with a display 504. The data processor 502 may communicate directly or indirectly, such as through a video controller, with the display 504. The display 504 could take any form, such as a cathode ray tube (“CRT”) monitor, liquid crystal display (“LCD”), light emitting diode (“LED”) screen, plasma display, or any other form of display.

A player interface 506 also communicates with the data processor 502. The player interface 506 may include an input device to communicate input from a player to the data processor 502. For example, the player interface 506 may include a button panel, mouse, keyboard, keypad, pointer, or the like. In an optional embodiment, the player interface 506 may be integrated with the display 504 into a touch screen display which is configured to receive input and display output.

A memory device 508 communicates with the data processor 502. The memory device 508 may include optical data storage, magnetic data storage, electrical data storage, Flash data storage, or any other form of data storage. The memory device 508 stores graphics, sounds, and data files to conduct a method according to an embodiment of the present invention. Additionally, the memory device 508 stores program instructions executable by the data processor 502 to conduct a game according to an embodiment of the present invention.

For example, in one such optional embodiment, a base game wager and a war base wager are received through the player interface 506. The receipt of the base game wager and war base wager may occur through physical receipt of the wager amounts through the player interface 506, such as receiving currency through a bill acceptor, coins through a coin receiver, a ticket or voucher through a ticket reader, account information through a keypad or magnetic card reader, or the like. Alternatively, receipt of the blackjack base wager and war base wager may occur through receipt of input designating wager amounts to be allocated from a stored register of game credits.

The data processor 502 deals a player war hand and displays the player war hand at the display 504. In an optional embodiment, the data processor 502 executes software or firmware to act as a random number generator, or cooperates with a software, firmware, or hardware random number generator to generate a random number. The memory device 508 stores a map correlating random numbers to playing cards or playing card combinations.

As discussed above, a player game hand may also be dealt by the data processor 502 and displayed at the display 504 with the initial player war hand that incorporates, or excludes, the player war hand depending on the optional embodiment. Alternatively, the player game hand may be dealt by the data processor 502 and displayed at the display 504 after resolution of the war base wager. In yet another optional embodiment, a player game hand may be dealt by the data processor 502 along with the player war hand (with the player game hand incorporating or excluding the player war hand) but without displaying the player game hand at the display 504 until after resolution of the war base wager.

Likewise, a dealer war hand is dealt by the data processor 502. Again, the dealer game hand may be dealt at the same time, or after the resolution of the war base wager. For example, in the optional embodiment in which the base game is blackjack and the dealer game hand incorporates the dealer war hand, the playing card of the dealer war hand may function as the exposed (i.e., face-up) playing card of the initial dealer blackjack hand. In the optional embodiment in which the dealer game hand and dealer war hand are separate, the dealer game hand may be exposed at the display 504 before or after resolution of the war wager and a decision whether to cap the base game wager with any war payout is received. For example, in one optional embodiment applied to blackjack, a face-up playing card is dealt to the player war hand along with a face-up playing card to be combined with the player war hand to form the initial player blackjack hand. Similarly, a face-up playing card is dealt to the dealer war hand along with a face-down playing card to be combined with the dealer war hand to form the initial dealer blackjack hand. Thus, in such an example, the display 504 displays three face-up playing cards and one face-down playing card after the war hands and initial blackjack hands are dealt.

The war base wager is resolved by the data processor 502 comparing the player war hand to the dealer war hand and determining whether the player war hand outranks the dealer war hand. In an optional embodiment, a war payout is issued if the player war hand outranks the dealer war hand and the war base wager is collected if the dealer war hand ties or outranks the player war hand. In an optional embodiment, any war payout is displayed at the display 504.

An election is received through a player interface 506 whether to cap, i.e., supplement, the base game wager. As discussed above, some or all (depending on the optional embodiment) of the war payout may be added to the base game wager prior to conducting a base game stage of a game. In one such optional embodiment, a prompt may be displayed at the display 504 when a war payout is issued to prompt input of an election whether to cap the base game wager. The election may then be input through the player interface 506. In an optional embodiment, the amount of the cap may be predetermined (such as the entire war payout, half the war payout, or other predetermined amount) or may be selectable by inputting an amount through the player interface 506.

The base game stage of the game is conducted by the data processor 502. As discussed above, the base game may be any game, including blackjack, baccarat, poker (or a variation thereon), or any other base game.

In an optional embodiment directed to blackjack, the base game includes dealing by the data processor 502 of an initial player blackjack hand, if it has not already been dealt. Likewise, a portion of the initial dealer blackjack hand is displayed at the display 504, if it has not already been displayed. A blackjack payout may be issued by the data processor 502 based on the blackjack base wager including any cap if the initial player blackjack hand is a blackjack, i.e., a two-card hand containing an Ace and a ten-value playing card, and the initial dealer blackjack hand is not a blackjack. In an optional embodiment, the blackjack payout when the initial player blackjack hand is a blackjack is greater than even money, e.g., 3:2, 6:5, or the like. Conversely, the blackjack base wager, including any cap, is collected by the data processor 502 if the initial dealer blackjack hand is a blackjack and the initial player blackjack hand is not a blackjack. In one optional embodiment, a push occurs and the blackjack base wager, including any cap, is returned by the data processor 502, if both the initial player blackjack hand and the initial dealer blackjack hand are blackjacks. It is contemplated that in alternate optional embodiments, tied hands may be resolved in favor of the house or player, or the tie may be broken by the data processor 502. As discussed above, a conventional insurance option may be displayed at the display 504 and elected through a player interface 506 in the event that the exposed card of the initial dealer blackjack hand is an Ace.

If neither the initial player blackjack hand nor the initial dealer blackjack hand contains a blackjack, a final player blackjack hand is formed. In an optional embodiment, elections are received through a player interface 506 to form a final player blackjack hand. As discussed above, the conventional options of hitting or standing may be input through a player interface 506. Additionally, options such as splitting, doubling down, and/or surrender may also be displayed at the display 504 and received through a player interface 506, depending on the optional embodiment and the content of the player blackjack hand. As above, in the event that the player blackjack hand busts in the course of forming the final player blackjack hand, the blackjack base wager plus any cap may be collected by the data processor 502 and play may be terminated.

After forming a final player blackjack hand, the data processor 502 forms a final dealer blackjack hand. In an optional embodiment, a final dealer blackjack hand is formed according to predetermined house rules as described above. If the dealer blackjack hand busts in the course of forming the final dealer blackjack hand, a blackjack payout (optionally, even money) is issued by the data processor 502 based on the blackjack base wager plus any cap and play is terminated.

If play has not been terminated due to a bust or a blackjack, the final player blackjack hand and final dealer blackjack hand are compared by the data processor 502 to the target value of twenty-one. A blackjack payout is issued by the data processor 502 based on the blackjack base wager plus any cap when the sum of the values of the playing cards in the final player blackjack hand is closer to the target value than the sum of the values of the playing cards in the final dealer blackjack hand is. Conversely, a blackjack base wager plus any cap is collected by the data processor 502 when the sum of the values of the playing cards in the final dealer blackjack hand is closer to the target value than the sum of the values of the playing cards in the final player blackjack hand is.

Any payouts may be dispensed via an output device associated with, or part of, the player interface 506. For example, an output device may take the form of a ticket printer, coin dispenser, card encoder, or the like. Additionally or alternatively, payouts may be added to a register of stored game credits or an electronic account.

While certain embodiments of the present invention have been shown and described it is to be understood that the present invention is subject to many modifications and changes without departing from the spirit and scope of the claims presented herein.

I claim:

1. A method for conducting a game utilizing physical game pieces and an electronic device which includes a random number generator to randomize said physical game pieces comprising:
receiving a base game wager and a war base wager;
dealing a player war hand consisting of at least one game piece from said electronic device;
dealing a dealer war hand consisting of at least one game piece from said electronic device;
resolving said war base wager by comparing said player war hand to said dealer war hand and issuing a war payout based on said war base wager when said player war hand outranks said dealer war hand;
receiving an election to supplement said base game wager with at least a portion of said war payout, if any, while said dealer war hand is exposed;
dealing a player base game hand from said electronic device, wherein said player base game hand includes said player war hand;
dealing a dealer base game hand from said electronic device, wherein said dealer base game hand includes said dealer war hand such that said step of receiving an election to supplement said base game wager is received while said dealer war hand is exposed;
conducting a base game using said player base game hand and said dealer base game hand to produce a base game outcome, wherein said base game outcome may take the form of at least a winning base game outcome or a losing base game outcome; and
resolving said base game wager by issuing a base game payout when said base game outcome is a winning base game outcome, or collecting said base game wager when said base game outcome is a losing base game outcome.

2. The method of claim 1 wherein said base game outcome may also take the form of a tie base game outcome and said step of resolving said base game wager further includes returning said base game wager when said base game outcome is a tie base game outcome.

3. The method of claim 1 wherein said step of receiving a base game wager includes receiving a designation of one of said player base game hand or said dealer base game hand for resolution of said base game wager.

4. The method of claim 1 wherein said step of receiving a war base wager includes receiving a designation of one of said player war hand or said dealer war hand for resolution of said war base wager.

5. The method of claim 1 further comprising receiving an election to supplement said base game wager with all of said war payout, if any.

6. The method of claim 1 further comprising receiving an election to supplement said base game wager with a predefined portion of said war payout, if any.

7. The method of claim 1 further comprising receiving an election to supplement said base game wager with a player-selected portion of said war payout, if any.

8. The method of claim 1 wherein said player war hand comprises a plurality of game pieces and said dealer war hand comprises a single game piece and said step of resolving said war base wager comprises comparing each game piece of said player war hand to said single game piece of said dealer war hand and issuing a war payout if a designated quantity of said game pieces of said player war hand outrank the single game piece of said dealer war hand.

9. The method of claim 1 wherein said dealer war hand comprises a plurality of game pieces and said player war hand comprises a single game piece and said step of resolving said war base wager comprises comparing each game piece of said dealer war hand to said single game piece of said player war hand and issuing a war payout if the single game piece of said player war hand outranks a designated quantity of said game pieces of said dealer war hand.

10. A method for conducting a game utilizing playing cards and an electronic device which includes a random number generator to randomize said playing cards comprising:
receiving a baccarat base wager and a war base wager and receiving a designation of one of a player baccarat hand or a dealer baccarat hand for resolution of said baccarat base wager and a designation of one of a player war hand or a dealer war hand for resolution of said war base wager;
dealing a player war hand consisting of a single game piece from said electronic device;
dealing a banker war hand consisting of a single game piece from said electronic device;
resolving said war base wager by comparing said player war hand to said banker war hand and issuing a war payout based on said war base wager when the war hand designated for the resolution of said war base wager outranks the war hand not designated for resolution of said war base wager;
receiving an election to supplement said baccarat base wager with at least a portion of said war payout, if any, while said dealer war hand is exposed;
dealing said player baccarat hand from said electronic device, wherein said player baccarat hand includes said player war hand;
dealing said banker baccarat hand from said electronic device, wherein said banker baccarat hand includes said banker war hand such that said step of receiving an election to supplement said base game wager is received while said dealer war hand is exposed;
conducting a baccarat game using said player baccarat hand and said banker baccarat hand to produce a baccarat outcome, wherein said baccarat game may include dealing a single additional playing card to said player baccarat hand and said banker baccarat hand based on the value, modulo ten, of the sum of the playing cards in said player baccarat hand and said banker baccarat hand, respectively, and wherein said baccarat outcome may take the form of a player winning baccarat outcome, a banker winning baccarat outcome, or a tie baccarat outcome; and
resolving said baccarat base wager by issuing a baccarat payout when said baccarat hand designated for resolution of said baccarat base wager is associated with a winning baccarat outcome, collecting said baccarat base wager when said baccarat hand designated for resolution of said baccarat base wager is not associated with a winning baccarat outcome, and collecting said baccarat base wager designating either baccarat hand for resolution of said baccarat base wager when said tie baccarat outcome occurs.

11. The method of claim 10 further comprising receiving an election to supplement said base game wager with all of said war payout, if any.

12. The method of claim 10 further comprising receiving an election to supplement said base game wager with a predefined portion of said war payout, if any.

14. The method of claim 10 further comprising receiving an election to supplement said base game wager with a player-selected portion of said war payout, if any.

15. The method of claim 10 wherein said game pieces comprise playing cards having ranks of Ace, 2, 3, 4, 5, 6, 7, 8, 9, 10, Jack, Queen, and King.

16. The method of claim 15 wherein said Ace has a value of one, said 2 through 9 have a value equal to their rank, and said 10, Jack, Queen, and King have a value of zero, and wherein said step of comparing said player war hand to said banker war hand comprises calculating the value of said player war hand, calculating the value of said banker war hand, and comparing the value of said player war hand to the value of said banker war hand.

17. A method for conducting a game utilizing physical game pieces and an electronic device which includes a random number generator to randomize said physical game pieces comprising:
receiving a poker base wager and a war base wager;
dealing a player war hand consisting of at least one game piece from said electronic device;
dealing a dealer war hand consisting of at least one game piece from said electronic device;
resolving said war base wager by comparing said player war hand to said dealer war hand and issuing a war payout based on said war base wager when said player war hand outranks said dealer war hand;
receiving an election to supplement said poker base wager with at least a portion of said war payout, if any, while said dealer war hand is exposed;
dealing a player poker hand from said electronic device, wherein said player poker hand includes said player war hand;
dealing a dealer poker hand from said electronic device, wherein said dealer poker hand includes said dealer war hand such that said step of receiving an election to supplement said base game wager is received while said dealer war hand is exposed;
conducting a base game using said player poker hand and said dealer poker hand to produce a poker outcome, wherein said poker outcome may take the form of at least a winning poker outcome or a losing poker outcome; and
resolving said poker base wager by issuing a poker payout when said poker outcome is a winning poker outcome, or collecting said poker base wager when said poker outcome is a losing poker outcome.

18. The method of claim 17 further comprising receiving an election to supplement said poker base wager with all of said war payout, if any.

19. The method of claim 17 further comprising receiving an election to supplement said poker base wager with a predefined portion of said war payout, if any.

20. The method of claim 17 further comprising receiving an election to supplement said poker base wager with a player-selected portion of said war payout, if any.
